(19) United States
(12) Patent Application Publication
(10) Pub. No.: US 2018/0033352 A1
(43) Pub. Date: Feb. 1, 2018

(54) PAPER PRODUCTS AND SYSTEMS AND METHODS FOR MANAGING PAPER PRODUCT SALES

(71) Applicant: Scott Alan Kufus, Longwood, FL (US)

(72) Inventor: Scott Alan Kufus, Longwood, FL (US)

(21) Appl. No.: 15/665,364

(22) Filed: Jul. 31, 2017

Related U.S. Application Data
(60) Provisional application No. 62/369,154, filed on Jul. 31, 2016.

(51) Int. Cl. G09F 23/12; G06Q 30/02

(52) U.S. Cl. CPC G09F 23/12; G06Q 30/0236; G06Q 30/0234

(57) ABSTRACT

In various implementations, a paper product may have a core with a token disposed on the core. The token may include one or more redemption codes that are associated with rewards. A paper product management system may include a paper product application (e.g., on a user device and/or a server), which may manage redemptions, decode redemption codes, monitor user redemptions, monitor user information, and/or monitor sales.

### CROSS-REFERENCE TO RELATED APPLICATION

This application claims the benefit of U.S. Provisional Patent Application No. 62/369,154 entitled “PAPER PRODUCTS AND SYSTEMS AND METHODS FOR MANAGING PAPER PRODUCT SALES” filed on Jul. 31, 2016, which is hereby incorporated by reference in its entirety.

### TECHNICAL FIELD

The present invention relates to paper products.

### BACKGROUND

Paper products are commonly bought and sold via physical and online stores. An American, for example, utilizes on average paper products equivalent to approximately 380 trees in a lifetime and spends on average $400/year on paper products. Although some consumers purchase a specific brand of paper product based on the brand, often many consumers merely pick up a brand that is convenient to purchase or on sale. In addition, as consciousness about paper waste increases, consumers may look to minimize paper product purchases, which may decrease overall sales.

### SUMMARY

In various implementations, paper products, such as paper towels, toilet paper, craft paper, thermal paper, etc., may include core with a token. The token may include one or more redemption codes, which may be redeemed for rewards. For example, rewards may include allowing a tree to be planted, gift cards, monetary gifts, coupons, and/or other appropriate rewards.

In various implementations, a paper product application (PPA) may facilitate management of paper product information. For example, the PPA may manage redemptions (e.g., receive redemption codes, decode redemption codes, allow redemptions, assign rewards, etc.) The PPA may manage sales and/or purchases of paper products. The PPA may manage user information such as groups associated with a user, sales, purchases, redemptions, incentives, rewards, commissions, etc. The operations of the PPA may be performed on a user device and/or a server associated with the paper product system.

In various implementations, a paper product may include a core and a length of paper product wrapped around the core. The length of paper product may include tear features, such as perforations, to facilitate removal of a sheet of the paper product. The core may include an inner surface and an opposing outer surface. Token(s) may be disposed on the outer surface of the core. A token may include one or more redemption codes that are redeemable for one or more rewards.

Implementations may include one or more of the following features. At least one of the redemption codes may include an image. A token may include a chance token. A token may include a paper product brand, packaging information, logo, slogan, and/or redemption information. A token may be affixed to, embossed on, or printed on the core of the paper product. Affixing the token to the core may add to the user enjoyment of the paper product since it adds an element of fun to finishing a roll of a paper product. The paper products may include a packaging that covers one or more of the paper products and one or more tokens may be disposed on the packaging (e.g., affixed, embossed, printed on, etc.).

In various implementations, a paper product system may include a plurality of paper products and a PPA operating on any appropriate computing device, such as a server. A paper product may include one or more tokens on an outer surface of a core of the paper product, and a token may include one or more redemption codes that are redeemable for at least one reward. The PPA may be stored on a memory of the PPA system along with other data, such as reward information, library of songs, associations information between groups of users, user information, associations between one or more of the redemption codes and one or more of the rewards, and/or any other appropriate information. A processor of the PPA system may execute instructions of the PPA to perform operations to manage the paper product redemptions. For example, user information may be received from a user. The user information may identify the user and/or one or more associated sets of users, where the user is a direct or indirect member of the one or more associated sets of users. At least one of the redemption codes on at least one of the tokens disposed on one of the outer surfaces of one of the paper products may be received (e.g., via a user interface generated by the PPA) from the user. Reward(s) for the user may be determined based on the received redemption code(s) and stored association(s) between the one or more redemption codes and the one or more rewards. In some implementations, rewards may be determined based on user information, previously redeemed redemption codes, redemption codes redeemed by associated users (e.g., in the same group, in a subset group, etc.). Rewards for a primary user may of at least one of the associated sets of users may be determined based on the received at least one redemption code. For example, a primary user may receive an incentive (e.g., merchandise, coupon, gift card, and/or other reward) based on the redemption of redemption codes by users in subsets of users (e.g., associated with the primary user).

Implementations may include one or more of the following features. An image of one of the tokens disposed on one of the outer surfaces of one of the paper products may be received to receive the at least one redemption code. For example, a user may capture an image via a phone camera and upload it to a PPA. The received image of one of the tokens may be decoded to determine one of more of the redemption codes. For example, the redemption codes may be identified in the token (e.g., using standard or custom decoding, and/or image recognition), the segments of a redemption code may be identified, etc. A redemption code may be associated with tree planting. The PPA may allow funding of a tree planting when a redemption code is redeemed by a user, by providing money to an organization that provides tree planting services. Reward(s) for the user based on the received redemption code(s) may include identifying a number of trees planted based on the user's purchase of the paper product associated with the redemption codes, in some implementations. The number of trees planted based on the user's purchase and/or the number of trees planted over a time period associated with the user may be tracked and/or stored in a memory (e.g., of a user device and/or associated with the PPA). The number of trees planted based on the user's purchase may be presented to the user and/or other users, such as a primary user of at least one of the associated sets of users, users in a group that the user is associated with, and/or a subset of users (e.g., to encourage others to purchase paper products and/or for marketing reasons). Determining rewards for the user based on the received redemption code(s) may include allowing the user to be entered into a lottery and/or determine whether at least one of the redemption codes is associated with a lottery reward. Determining reward(s) for the user based on the received redemption code(s) may include determining a debt payoff value associated with the at least one redemption code, receiving an identification of a debt from the user, and/or allowing the debt payoff value to be applied to the debt by allowing the debt payoff value to be credited to the debt. The user may be a primary user for one or more subsets of users. Determining reward(s) for the user may be based on received redemption codes from one or more users in at least one of the subsets of users and/or one or more purchases of the users in the one or more subsets of users. Determining and/or providing rewards for the user based on the received redemption code(s) may include allowing the user to download a song and/or providing at least one other reward to the user. In some implementations, a map may be generated (e.g., by the PPA system). A location of the user may be identified and/or presented on the map and/or a zone of influence may be identified and/or presented on the map. The zone of influence may include identifying a location of one or more users in one or more of the subsets of users.

In various implementations, managing redemption of tokens on paper products may include receiving user information from a user and receiving, from the user, at least one redemption code associated with one or more paper products. The user information may identify the user and one or more associated sets of users, where the user is a direct or indirect member of the one or more associated sets of users. A redemption code may be associated with a token disposed on one of the outer surfaces of one of the paper products. Rewards for the user and/or at least one primary user (e.g., of at least one of the associated sets of users) may be determined based on the received redemption code(s).

Implementations may include one or more of the following features. The user may be a primary user for one or more subsets of users. Purchases of users in the one or more subsets of users may be determined and reward(s) for the user may be determined based on purchases of the users in the one or more subsets of users. Determining reward(s) for the user based on the received at least one redemption codes may include determining a debt payoff value associated with the at least one redemption code and allowing the debt payoff value to be applied to the debt by allowing the debt payoff value to be credited to the debt. An identification of the debt to be paid off may be received from the user.

The details of one or more implementations are set forth in the accompanying drawings and the description below. Other features, objects, and advantages of the implementations will be apparent from the description and drawings.

### BRIEF DESCRIPTION OF THE DRAWINGS

For a more complete understanding of this disclosure and its features, reference is now made to the following description, taken in conjunction with the accompanying drawings, in which:

FIG. 1A illustrates a front perspective view of an implementation of an example core of a paper product.

FIG. 1B illustrates a front view of an implementation of the example core of a paper product illustrated in FIG. 1A.

FIG. 1C illustrates a front perspective view of an implementation of an example core of a paper product.

FIG. 1D illustrates a front view of an implementation of the example core of a paper product illustrated in FIG. 1C.

FIG. 1E illustrates a front perspective view of an implementation of an example core of a paper product.

FIG. 1F illustrates a front view of an implementation of the example core of a paper product illustrated in FIG. 1E.

FIG. 1G illustrates a front perspective view of an implementation of an example core of a paper product.

FIG. 1H illustrates a front view of an implementation of the example core of a paper product illustrated in FIG. 1G.

FIG. 1I illustrates a front perspective view of an implementation of an example core of a paper product.

FIG. 1J illustrates a front view of an implementation of the example core of a paper product illustrated in FIG. 1I.

FIG. 1K illustrates a front perspective view of an implementation of an example core of a paper product.

FIG. 1L illustrates a front view of an implementation of the example core of a paper product illustrated in FIG. 1K.

FIG. 1M illustrates a front perspective view of an implementation of an example core of a paper product.

FIG. 1N illustrates a front view of an implementation of the example core of a paper product illustrated in FIG. 1M.

FIG. 1O illustrates a front perspective view of an implementation of an example core of a paper product.

FIG. 1P illustrates a front view of an implementation of the example core of a paper product illustrated in FIG. 1O.

FIG. 2A illustrates a side view of an implementation of an example core for a paper product.

FIG. 2B illustrates an opposing side view of an implementation of an example core for a paper product.

FIG. 3 illustrates a back view of an implementation of an example core for a paper product.

FIG. 4 illustrates an implementation of a paper product system.

Like references in the various drawings indicate like elements.

### DETAILED DESCRIPTION

Paper products may include toilet paper, paper towels, hand towels, facial tissues, wrapping paper, craft paper, thermal paper (e.g., for thermal printing of items such as receipts) and/or other paper products. The paper products may include a strip of paper wrapped around a core. The paper may be segmented (e.g., perforated) to facilitate separation of portions of the paper from the strip during use. The paper may be coupled to itself and/or the roll to retain at least a portion of the paper on the core. In some implementations, the paper may not be coupled to the roll and may release from the core upon use of the part of the paper closest to the core.

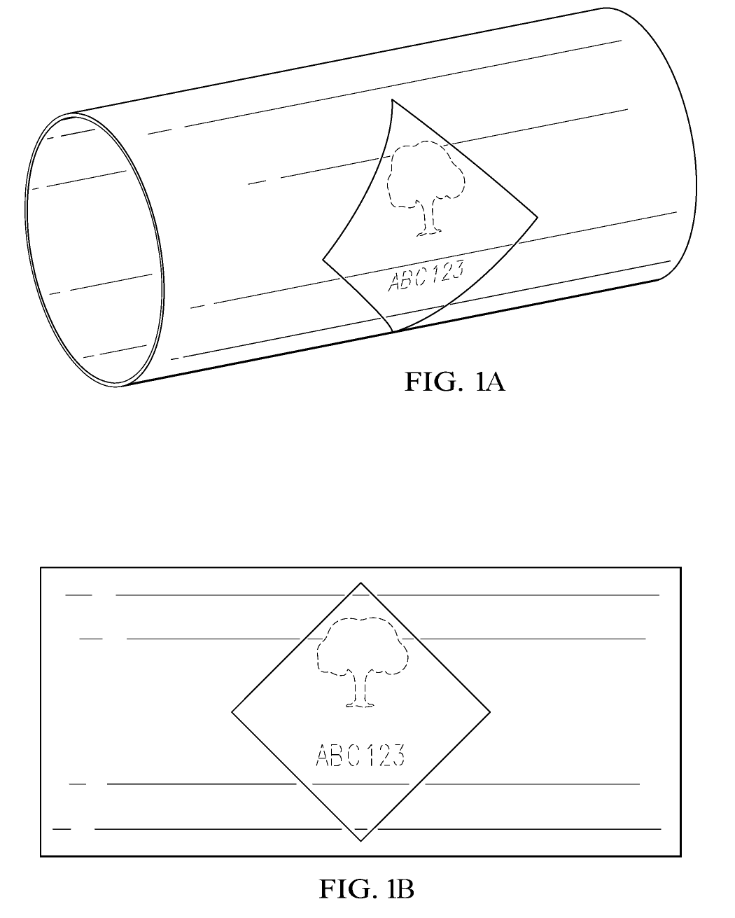

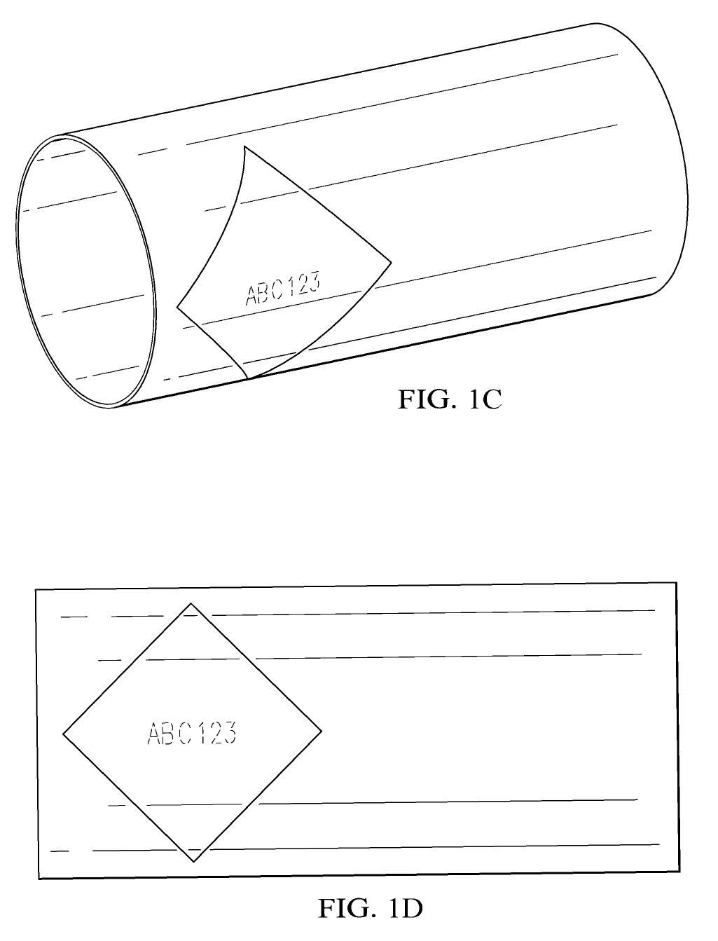

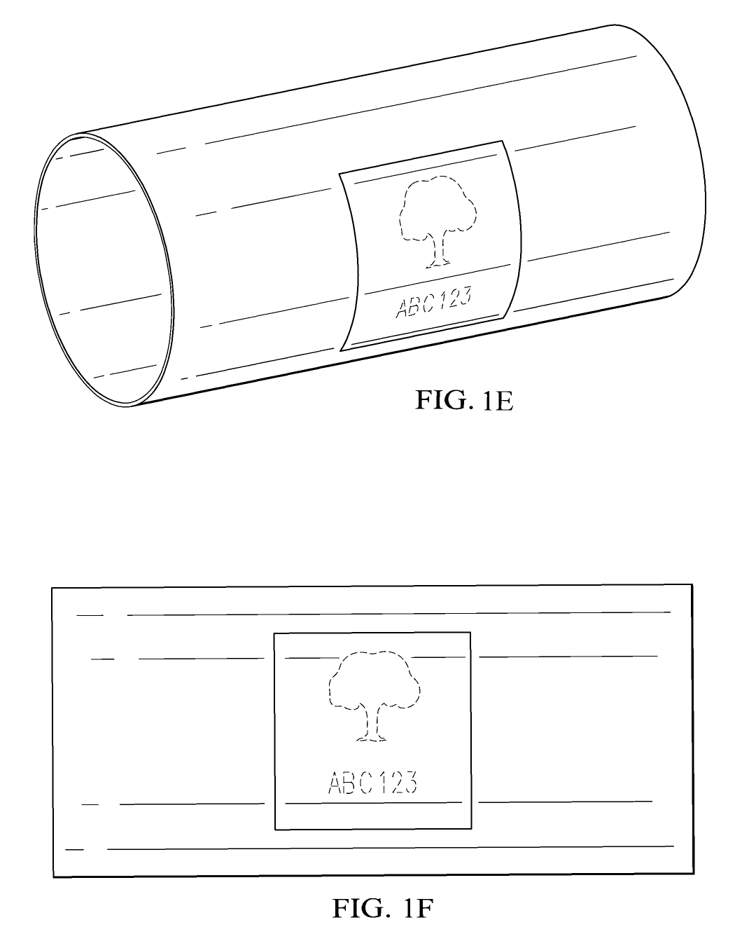

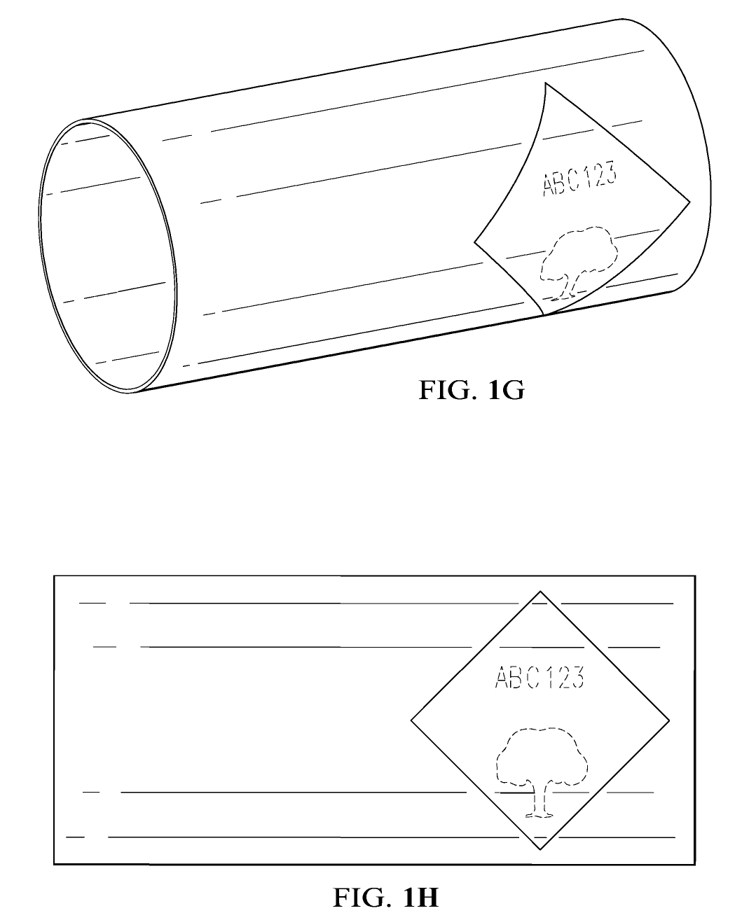

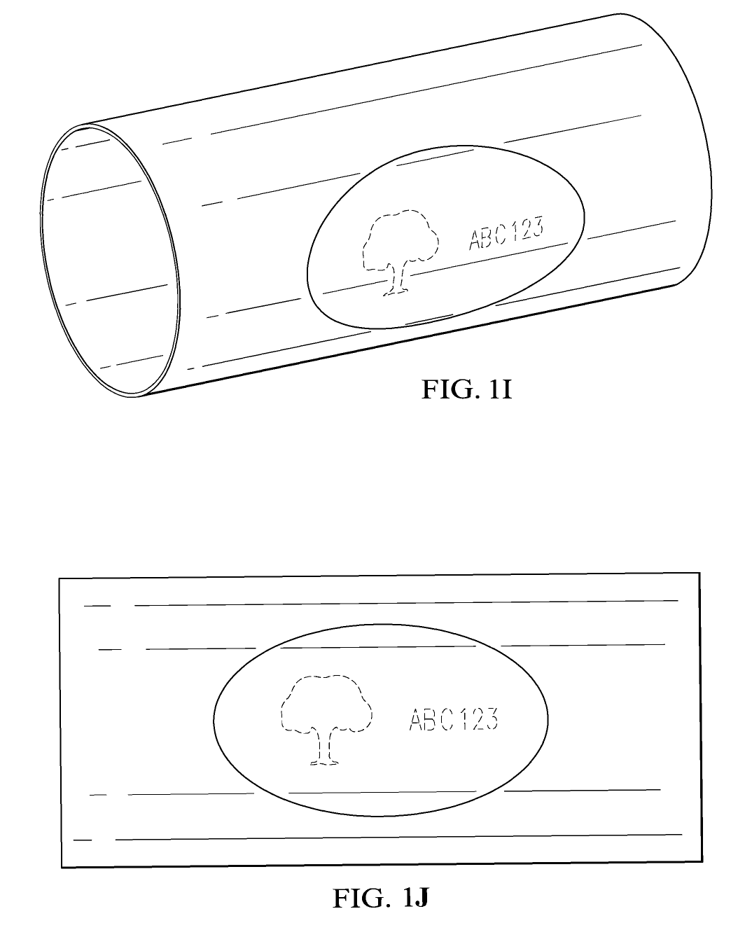

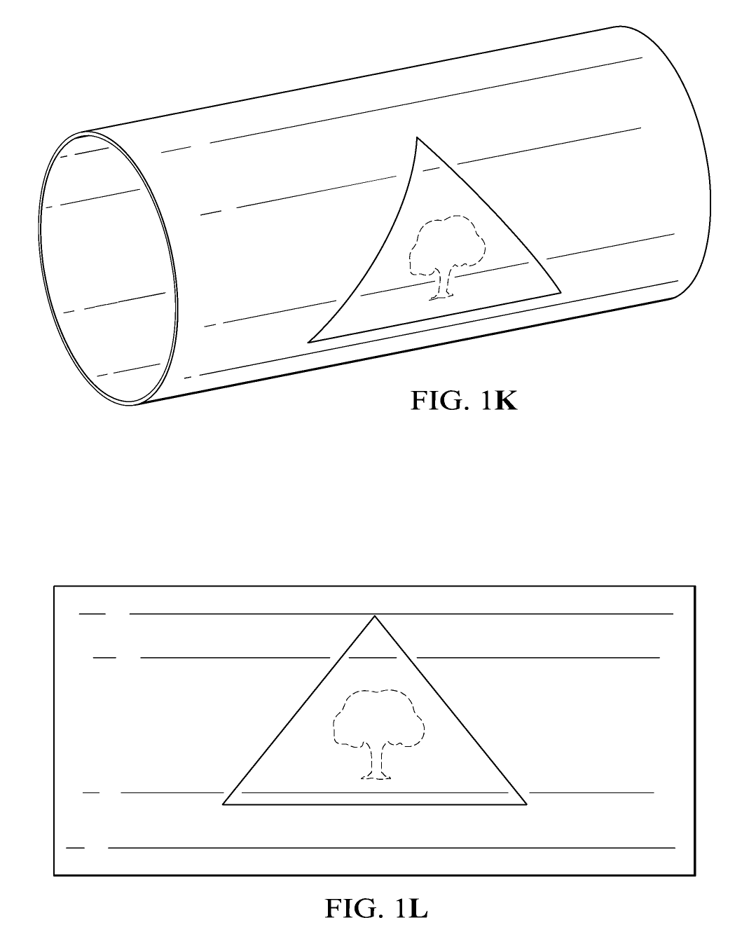

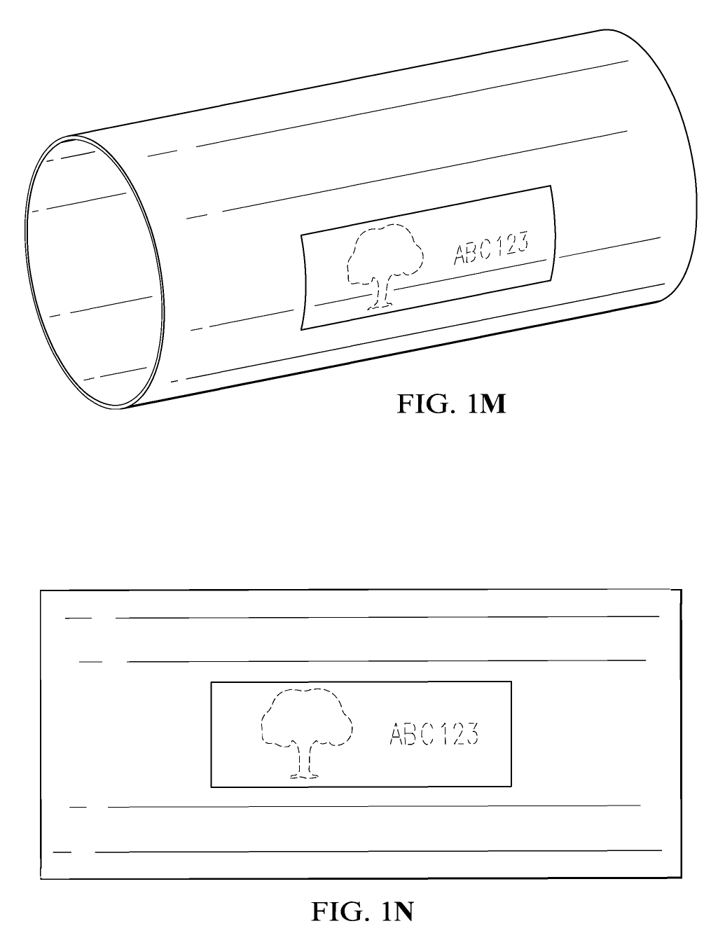

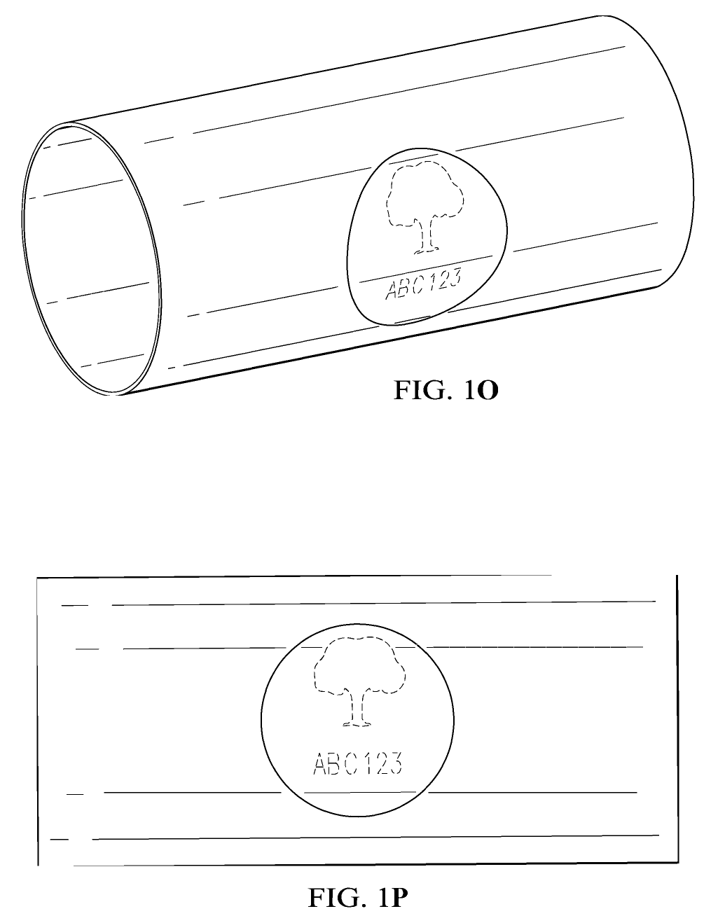

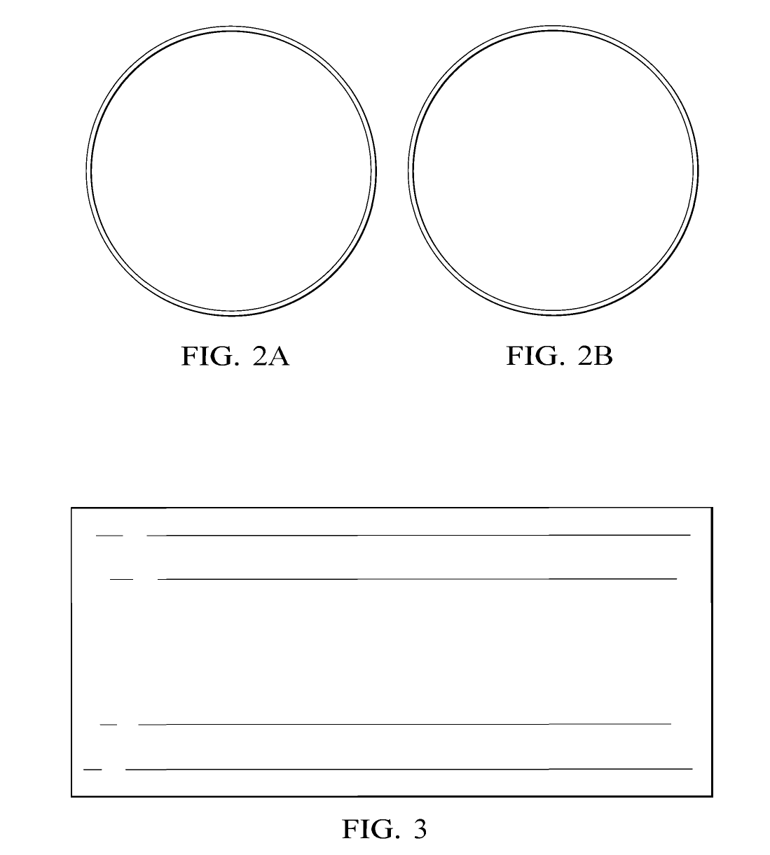

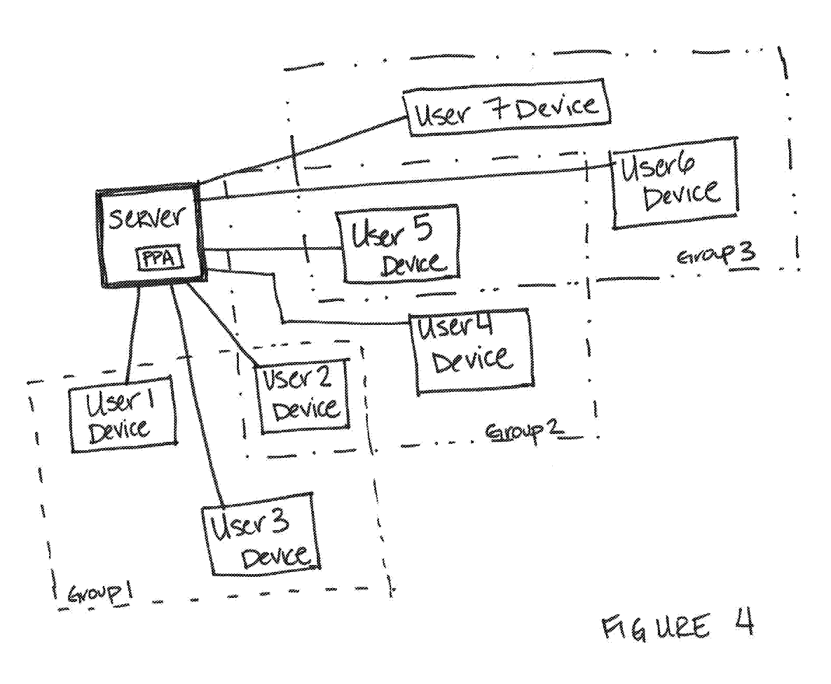

The core may be any appropriate size and/or shape. For example, the core may have a cross-sectional shape across at least a portion of a length of the core. The cross-sectional shape may be circular, oval, rectangular, square, and/or any other appropriate regular or irregular shape. The core may be a solid conduit. The core may be a conduit with a cavity disposed through the conduit (e.g., to facilitate insertion of the paper product in a holder, to reduce core costs, etc.), such as a tube. FIGS. 1A-1P illustrate front perspective views of implementations of example cores. FIG. 2A illustrates a side view of a first side and FIG. 2B illustrates a second opposing side view of a core, such as the cores illustrated in FIGS. 1A-1P. FIG. 3 illustrates a back perspective view of a core, such as the cores illustrated in FIGS. 1A-1P.

The core may include any appropriate material, such as paperboard, plastic, etc. The core may be a tube formed from a sheet of material such as paperboard, in some implementations.

The core may include an inner surface and an outer surface. The core may include a token, which may be, as a not limiting example, associated with rewards that a user may obtain (e.g., via the paper product system). For example, redemption codes of a token may be associated with one or more rewards such as, but not limited to, contest entries, awards, prizes, gift cards, monetary awards, debt payoffs (e.g., mortgages, student loans, credit cards, etc.), debit cards, food, discounts, coupons, and/or any other appropriate type of award.

The token may include any appropriate shape(s). For example, the token may be a single shape and/or multiple joined or unjoined shapes. The token may include any appropriate shape such as a diamond (e.g., rotated square or rectangle to be disposed at an angle), as illustrated in FIG. 1A; square, as illustrated in FIG. 1E; rectangle, as illustrated in FIG. 1M; oval, as illustrated in FIG. 1I; circle, as illustrated in FIG. 1O; triangle, as illustrated in FIG. 1K; any other appropriate regular shape; any appropriate irregular shape; and/or combinations thereof.

The token may include any number of redemption codes disposed in the token. For example, the token may include a single redemption code. In some implementations, more than one redemption code may be disposed in the token. For example, two redemption codes may be disposed in a token, as illustrated in FIG. 1A. When more than one redemption code is disposed in the token, any appropriate arrangement of the redemption codes relative to each other may be utilized. For example, the redemption codes may be disposed such that one is disposed above the other, as illustrated in FIG. 1A; the redemption codes may be disposed side by side, as illustrated in FIG. 1M; and/or any other appropriate arrangement. In some implementations, other images and/or text may be disposed in the token. For example, a paper product brand, packaging information, other logos, slogans, redemption information, etc. may be disposed in the token.

In various implementations, a token may be disposed on an outer surface of the token. The token may be disposed at any appropriate position on the outer surface. FIGS. 1A-1P illustrate implementations of example cores with tokens disposed in different positions. As illustrated in FIGS. 1A, 1B, 1E, 1F, and 1I-1P the token may be disposed proximate a center of an outer surface of the core. As illustrated in FIGS. 1C and 1D, the token may be disposed proximate a first end of the core (e.g., at the end of the core and/or closer to the first end of the core than an opposing second end of the core). As illustrated in FIGS. 1G and 1H, the token may be disposed proximate a second end of the core.

In some implementations, a token may be disposed on the outer surface of the core such that a token and/or redemption codes of the token may be viewed, by a user, from a first side of the core. For example, the token and/or may be disposed on a first half of an outer surface of the core and may not be disposed on the second opposing half of the outer surface of the core. In some implementations, the token may extend into a second surface while the redemption codes of the token may be disposed on the first side of the core. In some implementations, as illustrated in FIGS. 1A and 3, the token may be disposed on the outer surface such that the token is visible to a user on a first side and not visible to the user on a second opposing side. Utilizing a token that is disposed on a first side (e.g., first half of an outer surface and/or portions thereof) may increase user satisfaction (e.g., when compared with a token disposed on multiple sides) with the paper product and associated systems by allowing the user to view the token without rotating the core. In some implementations, inputting redemption codes on redemption codes may be facilitated by disposing a token and/or redemption codes on a first side since imaging the redemption code may be facilitated when the redemption code can be captured in a single still image (e.g., rather than multiple still images and/or a video). In some implementations, the token or portions thereof may extend from a first side to the second opposing side.

In some implementations, the token may be printed on, embossed on, and/or otherwise appropriately disposed on the outer surface of the core. In some implementations, the token may include a sticker (e.g., adhesive label) that is affixed to the core. The token may be integrated with the core, in some implementations. For example, paperboard may be produced with the token integrated in the paper board (e.g., via different color fibers, via raised or depressed images and/or text, etc.).

Although various implementations have described tokens on cores of paper products, in some implementations, described tokens may be disposed on packaging associated with paper products. For example, token(s) (e.g., including portions with one or more redemption codes) may be disposed on packaging for a set of toilet paper (e.g., in addition to and/or in place of a token on each roll). In some implementations, a token may be disposed on packaging for non-rolled paper products, such as but not limited to printer paper, coreless paper products (e.g., coreless toilet paper), wipes (e.g., in a pop up dispenser), paper plates, paper cups, greeting cards, napkins, paper party ware, etc. In some implementations, tokens may be utilized on nonpaper products.

The token may be any appropriate shape(s). For example, the token may be a single shape (e.g., regular or irregular) disposed on the core and/or packaging. In some implementations, the token may include multiple shapes disposed on the core. The shapes may be rotated (e.g., to be presented at an angle relative to the length of the core). As illustrated in FIG. 1A-1C, the token may include a diamond shape (e.g., rotated square or rectangle). As illustrated in FIG. 1D, the token may include a square shape. FIG. 1E illustrates an implementation of an example token that is oval, and FIG. 1F illustrates an implementation of an example token that is circular. As illustrated in FIG. 1G, the token may be triangle shaped. As illustrated in FIG. 1H, the token may be rectangular shaped.

In some implementations, the token may include one or more redemption codes. The token may or may not include a divider (e.g., line, image, color change, and/other appropriate demarcation) between redemption codes, in some implementations. The redemption codes may be disposed in any pattern in the token. For example, a token may include two parts each with a redemption code. In some implementations, a token may include a single redemption code with additional images and/or text (e.g., brand name, logos, illustrations, slogans, paper product information, etc.).

Redemption codes may include one or more images and/or text. For example, a token may include a first redemption code that includes images of one or more trees. The image selected for the first redemption code may have a nature connotation (e.g., leaves, trees, etc.), in some implementations. The first redemption code may be associated with a reward that includes planting tree(s) (e.g., performed by a third party service, such as the US Forest Service or American Forests, and/or by groups of users). In some implementations, the type and/or number of trees included in the first redemption code may be associated with a first reward. For example, a first tree image, such as an elm tree, may indicate that a predetermined quantity of trees, such as a half tree, will be planted (e.g., directly or indirectly) by a company with each packaged set of paper product purchased or each roll of paper product purchased. A second redemption code may include an identifier such as a text (e.g., numbers, letters, symbols, emojis, etc.), bar code, QR code (e.g., custom or customary), etc. In some implementations, a redemption code may include a code within an image and/or a code that is designed to look like an image. For example, the redemption code may include a QR code in an image of a tree or a QR code or a portion there of designed to look like a tree. The identifier may be associated with a second reward. For example, a user may enter and/or scan (e.g., via a mobile device) the code to associate the purchase of the product with the user's account, to enter the user in a chance to win a prize, and/or to redeem a reward (e.g., gift card, coupon, discount, etc.).

The token may include any appropriate number of redemption codes. In some implementations, the redemption code may be the same and/or vary in a packaged set of paper products. For example, one roll of paper product may include the redemption codes in each packaged set. In some implementations, each roll of paper product in a packaged set (e.g., one or more) may include a different or the same redemption codes.

In some implementations, the token on a paper product (e.g., on a core and/or packaging) may be based on the type of paper product, the packaged set in which the paper product was purchased, the location in which the paper product was purchased, the storefront in which the paper product was purchased, current reward offers, and/or any other appropriate criteria. For example, a larger packaged set may include tokens with redemption codes associated with higher rewards (e.g., more planted trees, higher point values, higher gift cards, etc.) than smaller packaged sets. In some implementations, paper products purchase via the PPA may include PPA tokens (e.g., associated with special rewards available only with purchase via the PPA), tokens associated with higher rewards than similar products purchased via different storefronts, and/or similar tokens as paper products purchased via different storefronts.

In some implementations, tokens on the core of a paper product may include tokens associated with promotions and/or incentives. For example, promotion tokens may be associated with rewards for a predetermined time period (e.g., $5 gift card in the month of May, plant 2 extra trees in 2001 with the redemption of 5 promotion codes, etc.). Incentive tokens may include tokens associated with incentives offered by the paper product system and/or user(s). For example, a user may order and/or provide to others custom or predetermined incentive tokens for paper products. The user may provide the paper products with incentive tokens to referrals, users in associated groups, etc.

In some implementations, tokens on the core of a paper product may include chance tokens. For example, a chance token may provide entry in a lottery for a prize (e.g., cash, paper products, and/or other rewards). The chance token may be in addition to or in place of other redemption codes on a token.

In some implementations, a redemption code may be provided to a paper product system (e.g., PPA) to redeem a reward. In some implementations, one or more redemption codes may be automatically redeemed. For example, a first redemption code (e.g., associated with a reward of planting a tree) may be automatically redeemed by the purchase of the product. The PPA may track a sale of a paper product with a first redemption code, automatically redeem the first redemption code(s) associated with the purchased product, and allow trees to be planted (e.g., via payment to a tree planting service). In some implementations, a token may include one or more redemption codes that are automatically redeemed and one or more redemption codes that are redeemed when provided by a user (e.g., to the PPA).

Since use of paper products often includes destruction of trees, users may be motivated to purchase paper products that promote regrowth of forests. In some implementations, a token may include a redemption code associated with tree planting. For example, the token may include a first redemption code such as image(s) of tree(s). A type and/or number of tree(s) may be associated with planting of a predetermined number of tree(s). For example, paper product tokens may include a first set of tree varieties, such as, but not limited to, elm, spruce, oak, and/or maple. Each tree in the set of tree varieties may be associated with a specific number of tree plantings. For example, an elm may be associated with ½ a tree planting, a spruce may be associated with 1 tree planting, an oak may be associated with 10 tree plantings, and/or a maple tree may be associated with 100 tree plantings. Thus, a token may include an oak tree to indicate that redemption will cause 10 trees to be planted (e.g., via government entity, such as the US Forest Service; via a private entity, such as American Forests; via groups of users, etc.). In some implementations, two spruce trees on a token may indicate that 2 trees will be planted when the token is redeemed. In some implementations, the token may be provided to the PPA, the PPA may decode the redemption code, the PPA may transmit a notification to the user via the PPA regarding the reward, and/or the PPA may allow redemption of the reward (e.g., at set time periods, concurrent with user redemption, etc.). For example, the PPA may transmit payment to an entity such as the US Forest Service to plant tree(s) based on the redemption by the user.

In various implementations, the token(s) may be utilized in a paper product system. FIG. 4 illustrates an implementation of a paper product system 100. The paper product system may include paper products with token(s) and a paper product application (“PPA”), which may be stored on and/or whose operations may be performed by user device(s) and/or a server (e.g., any appropriate including cloud based server network). As illustrated, the system includes a server that is communicably coupled to one or more users via user devices (e.g., laptop, mobile device, tablet, etc.).

The PPA may allow paper product purchases and/or sales (e.g., with and/or without tokens on the cores and/or packaging). The PPA may monitor paper product purchases (e.g., direct purchases and/or indirect purchases) and/or sales (e.g., providing information on inventor, redemptions, distribution network, delivery information such as times, etc.). The PPA may manage and/or monitor the redemptions associated with paper products; manage and/or provide commissions associated with paper product sales: may manage scoreboards for users; manage groups of users; may suggest groups of users; allow creation of incentive programs; monitor referrals; and/or perform other operations appropriate for the paper product system.

In various implementations, the PPA may include a storefront (e.g., a link, graphical user interface, or storefront in an app and/or website) to allow purchases of paper products via the PPA. The paper products ordered may be directly shipped to the consumer. In some implementations, the paper products ordered may be shipped and/or purchased via third parties (e.g., Amazon, Walmart, etc.). The PPA may present options (e.g., types of paper products; properties of the paper product such as percent post-consumer waste, etc.) for the user to select from in some implementations. The PPA may allow subscriptions (e.g., automatically delivered selected order to a user on a predetermined repeating schedule) to be established for one or more users by the user and/or by other users (e.g., a user that sold a second user a subscription). In some implementations, subscriptions may increase user satisfaction by simplifying paper product ordering, reducing time spent ordering paper products annually, automatically delivering products, allowing users to anticipate costs (e.g., since costs may be predetermined and/or notification may be provided when costs increase), etc. In some implementations, samples and/or paper products with incentive tokens may be delivered as part of an order (e.g., single order, repeat order, and/or subscription order). The PPA may associate the sales via the PPA with the user that purchase the product and/or one or more users associated with the user (e.g., for commissions, points, other rewards and/or reward levels, and/or other incentives).

As illustrated in FIG. 4, a first user (e.g., associated with user device 1) may be a member of group 1, which also includes User 2 and User 3. User 2 is a member of group 1 and group 2, which also includes User 4 and User 5. User 5 is a member of group 2 and group 3, which includes User 6 and User 7. In some implementations, a group may include users that a first user referred to the PPA. For example, a first user may post a link on social media encouraging others to download and/or purchase via the PPA, and when a second user downloads and/or purchases via the link (e.g. directly or indirectly) the second user is placed in a group with the first user. In some implementations, the second user may tag the first user as their referral via the PPA to be associated with the first user. As users refer other users to the PPA, a network of users and their devices may be groups and linked based on how they joined the PPA (e.g. via referrals), self created groups, and/or PPA created groups. As users in groups related to the first user make purchases and sales, the first user may receive commissions, incentives, additional reward levels, and/or other benefits. For example, in reference to the groups illustrated in FIG. 4, User 1 may receive a commission based Users 2-7, User 2 may receive commissions based on Users 4-7, and User 3 may not receive commissions based on other Users illustrated in FIG. 4. As illustrated, User 1 may be the primary user for Group 1, User 2 may be the primary user for Group 2, and User 5 may be the primary user for Group 3. From the perspective of User 2, Group 2 is a level 1 subset group since the group includes people referred by User 2, and Group 3 is a level 2 subset group since the group includes people referred by User 5 who was referred by User 2. If User 7 referred a group of users as Group 4, Group 4 would be a level 3 subset of users, since user 7 referred the users in Group 4 and User 7 was referred by User 5 who was referred by User 2. In some implementations, a user may receive compensation based on users behavior in a predetermined level (e.g., all, 3, etc.) of subsets associated with the User. Thus, the associations between users may be stored in a memory of the PPA system, tracked by the PPA system, and/or utilized in determining reward(s) for a the User.

In various implementations, a user may download the PPA on a user device. The PPA may be stored on a memory of the user device (e.g., local memory and/or remote memory, such as cloud based memory) and executed by processor(s) of the device to perform operations of the PPA. The PPA may access components of the user device such as input component(s) (e.g., keyboard, camera, NFC components, touchscreen, etc.), presentation component (e.g., screen, speakers, etc.), communication components (e.g., WiFi components, NFC components, and/or mobile data communications such as 4G and/or LTE), and/or other appropriate components to perform one or more of the operations of the PPA.

The PPA may receive user information (e.g., user identification, password, token, etc.) from the user and authenticate the user information. For example, a first user may select PPA on the user device and load the application. The first user may transmit user information (e.g., automatically and/or manually) to the PPA.

A first user may utilize the PPA on the user device to manage, transmit to the server, and/or store redemption codes provided by the first user. A user device may be utilized to input redemption codes from tokens on paper product(s). For example, the user device may include a keyboard to input the redemption code(s) (e.g., text redemption code), a camera to scan or otherwise image the redemption code(s) (e.g., image and/or text redemption code), a NFC chip to detect the redemption code(s), etc. The PPA may decode the redemption code and/or present (e.g., audio, visual, and/or tactile notification via a presentation device of the user device) the reward associated with the redemption code. For example, a user may provide, via the PPA, a redemption code, such as an image of a tree, (e.g., using a camera of the user device and/or by selecting the redemption code from a list of redemption codes presented via the PPA) and the PPA may determine (e.g., via the PPA on the user device and/or the server) the reward (e.g., a tree will be planted), associated with the provide image. The provided redemption code may be associated with the user, in some implementations.

The PPA may transmit (e.g., via the user device) the provided redemption code(s) to the PPA on the server, in some implementations. The PPA may determine rewards (e.g., prizes, services that will be performed, etc.) associated with the redemption code. The PPA may transmit the rewards (e.g., purchase and/or transmit gift card) to the user and/or transmit notifications to allow services associated with the rewards to occur (e.g., transmit a payment and/or request to national park service to plant a tree). The PPA (e.g., on the user device and/or server) may manage rewards, sales associated with the redemptions and/or users, manage user information (e.g., rewards associated with user, sales by user, purchases by user, groups associated with user, etc.), and/or any other appropriate operation.

In some implementations, the PPA on the user device and/or a server of the paper system may perform one or more operations of the PPA independently and/or jointly. For example, the PPA (e.g., the user device and/or server independently and/or in conjunction with each other) may manage redemptions by a first user, redemptions by groups of users (e.g., identified by the first user and/or PPA), sales by the first user and/or groups of users associated with the first user, scoreboard(s), rewards, purchases, inventory, distribution, social media posts, payments, etc. The PPA on a server may facilitate redemption, communication with third parties, storage of user information (e.g., sales, group memberships, etc.), and/or any other appropriate operation.

In some implementations, the PPA may allow a first user to associate with a group of users (e.g., one or more other users). For example, a first user may refer second users to the PPA (e.g., via an email link, post on social media, etc.). When one or more second users download PPA on user device(s), the second user(s) may be associated with the first user (e.g., the PPA may automatically associate the first and second users, a second user may provide a code when downloading the PPA that associates the second user with the first user, etc.). The PPA and/or the first user may provide an incentive to the second user to associate with the first user and/or download the PPA. For example, the first user may share points (e.g., for a scoreboard) to provide to users that associate with the first user. The first user may purchase (e.g., via money and/or points) incentives (e.g., reward cards, paper products, coupons, etc.) via the PPA to provide as an incentive to the second user(s) to associate with the first user via the PPA. In some implementations, the paper product system, via the PPA, may provide incentives to the first user and/or the second users to encourage associates and/or encourage users to use PPA.

In some implementations, additional association(s) may be created between a first user and group(s) of user(s). For example, a first user may search and find other users and create a friend association with the found users. Users in a group may set up competitions, goals, etc. The PPA may provide incentives for the group and/or rewards to competitions. In some implementations, the PPA may suggest associations to users. For example, the PPA may suggest forming an association between high sellers (e.g., sales above an predetermined level over a predetermined time period). The PPA may provide points, incentives, rewards, and/or other services to groups of associated users.

In some implementations, the PPA may adjust a first user's information based on activity of an associated group. When one or more second users in a group associated with the first user make sales, redemptions, and/or referrals, the PPA may provide points and/or commissions to the first user. For example, a first user may receive a point value for every referral of a second user that results in a new user (e.g., the first user may receive a half point and the second user may receive a half point for a new user). In some implementations, a first user may receive a point value and/or commission for each sale and/or purchase by the second user (e.g., the first user may receive a quarter point for each sale by the second user and a half point for each purchase by the second user). In some implementations, the first user may be associated with other groups associated with second users or other users (e.g., secondary, tertiary, etc. associations) that are associated with the first user. For example, one or more second users may create third group(s) of associations (e.g., via referrals, sales, redemptions based on second user sales, etc.) and the first user may be associated to a third group based on the first user's association with a second user associated with the third group. The PPA may provide points based on these associations (e.g., for sales, purchases, referrals, redemptions, etc.).

In some implementations, the PPA may track sales of users. The PPA may allow sales and/or purchases through the PPA and/or may record sales from other sources. For example, when a user provides a redemption code for decoding, the PPA may associate it with a new purchase or an existing purchase may be recorded. In some implementations, the user may indicate whether the purchase was made (e.g., via the PPA, from another user, at a store, etc.). In some implementations, the redemption code may indicate if the purchase was via the PPA and/or via another source (e.g., different codes may be utilized for at least one source, in some implementations). The PPA may track sales and/or purchases of users associated with user. In some implementations, the PPA may provide commissions, points, incentives, and/or rewards based at least partially based on sales and/or purchases of users associated with a user. For example, purchases of paper products by second users associated with a first user may be tracked using purchases made via the PPA and/or via input by the second users of redemption codes. The PPA may determine which user(s) (e.g., first users and/or other users) are associated with the second user(s). The PPA may assign a point value (e.g., 2 points for every sale), commission (e.g., 0.005% of purchase price), incentive (e.g., 100 points for every 100 purchases by a user referred by the first user, gift card, rebate, coupon, etc.), and/or reward (e.g., qualify for different reward levels based on sales and/or purchases by others) based on the purchases by the second user(s).

The PPA may generate and/or manage a scoreboard for a user and/or group of users. The score board may accumulate points based on actions of the user and/or groups of users associated with the user. For example, the user may receive a first point value for downloading the app, a second point value for referring user(s) (e.g., per user and/or for all referrals), a third point value(s) for providing redemption code(s), fourth point value for redemption code(s) provided by groups of users associated with the first user, a fifth point value for purchases, a sixth point value for sales, a seventh point value for achieving levels (e.g., of sales, on scoreboard, etc.), and/or other appropriate point values for other appropriate actions. The PPA may monitor point accumulation for the user and/or present the point history (e.g., accumulation and/or spending) to the user via graphical user interfaces generated by the PPA. In some implementations, points may be counters for commissions, sales and/or purchases.

The points (e.g., displayed on the scoreboard of the PPA presented on a user device) may be redeemed. For example, the points may be redeemed incrementally and/or at set time periods (e.g., end of a quarter). Points may be redeemed for rewards based on the amount of points a user redeems. For example, points may be redeemed for additional planting of trees, opportunities (e.g., tree planting party for a group) paper products, discounts, and/or monetary rewards. The monetary rewards may be in the form of gift cards, deposits in user accounts (e.g., PayPal account, account associated with the PPA, and/or bank account), payments to other parties on behalf of the user (e.g., user loans, such as mortgages and/or credit cards; charities, etc.), and/or any other appropriate form of monetary reward. The PPA may interface with one or more external systems to automatically process and deposit the monetary rewards redeemed by a user.

In some implementations, the scoreboard may include a map. The map may illustrate a first user's location and/or location(s) of users associated with the first user. The map may include sales and/or purchases of one or more of the users on the map. Illustrating the first user's influence among friends may increase user satisfaction (e.g., by visually illustrating growth in sales avenues, influence among people, etc.) and/or increase sales of paper products (e.g., as groups of users increase, more tokens may be redeemed and their associated paper products sold). Visually indicating growth of influence may encourage users to grow zones of influence in specific geographic areas or world-wide. In some implementations, the map may illustrate other users' locations (e.g., city) and user's associated with these other users'. First user and/or other users may be encouraged to grow sales avenues and/or zones of influence by seeing other users' sales avenues and/or zones of influence on the map(s). For example, the PPA and/or a group of users may create a group of high sales users (e.g., sales greater than a predetermined value). The PPA may generate map(s) that track each member of the group's associated users. Thus users in the group may compete against each other and/or be encouraged by others to grow the largest sales network and/or zone of influence in a group and/or be inspired to expand a sales network and/or zone of influence based on other users in the group. The PPA may provide incentives to encourage growth (e.g., when a user views a map, the PPA may generate an incentive to encourage growth).

In some implementations, the scoreboard may allow monitoring, accumulation, and/or redemption of provided redemption codes by a user. For example, a user may provide a plurality of redemption codes that the PPA may monitor. The user may opt to immediately redeem a redemption code for a reward and/or accumulate redemption codes. For example, some high value rewards may be associated with a single higher value redemption code and/or multiple lower value redemption codes. Thus, a user may delay redemption of a lower value redemption code and accumulate enough lower value redemption codes to redeem the high value reward (e.g., larger gift card, more choices for redemption, etc.). When the user is ready to redeem redemption codes for rewards, the user may access the scoreboard to identify the value of a plurality of provided redemption codes and/or redeem the redemption codes. In some implementations, the redemption codes may be redeemed for points in the scoreboard that may be combined with points from referrals, commissions, etc.

In some implementations, the PPA may allow monitoring of inventory and/or distribution. For example, order tracking and/or delivery of sales by users may be tracked. A paper product company may be able to track sales, redemption of tokens, and/or deliveries via the PPA (e.g., a website generated by a web server of the PPA).

In some implementations, the PPA may allow posting to various social media. For example, a graphical user interface of the PPA may include links to post to social media such as Facebook, Twitter, Vine, etc. In some implementations, the PPA may include a set of template posts. A user may select one or more of the template posts from the set and a social media platform in which to post the selected template post. A template post may include one or more tokens in some implementations. By utilizing sets of template posts, a paper product company may be able to control and/or promote desired messages related the paper product, in some implementations. A template post may be utilized by a user in conjunction with referrals, incentives, etc. to expand a zone of influence and/or sales network. User enjoyment may be increased via template posts since template posts may include creative and/or unique ideas (e.g., funny videos and/or special effects), may increase user presence on social media (e.g., since template posts may be created to increase following by other users), and/or may be easy to utilize (e.g., since template posts may be quickly selected and/or edited).

In some implementations, the PPA may interface with one or more other applications on the user device and/or in communication with the user device to provide one or more additional services, such as tax management, book keeping, advertising, etc.

In some implementations, the PPA may organize and/or support planting parties. For example, group(s) of users may collect a number of trees to plant based on redemptions and the paper product system may send trees (e.g., seeds, seedlings, etc.) to the group(s) of users to plant (e.g., at a specific site and/or at user selected sites, such as local school, parks, etc.).

In various implementations, a paper product system may include a plurality of paper products and a PPA. The paper products may include any appropriate paper product such as paper towels, toilet paper, etc. A paper product and/or paper product packaging may include one or more tokens, which may be redeemed for rewards. A paper product may include a core and a length of paper product wrapped around the core. The length of paper product may be coupled directly to the core and/or coupled to itself to couple the paper product to the core. The core may include an inner surface and an opposing outer surface. The core may include one or more tokens disposed on the outer surface of the core (e.g., affixed to, embossed on, printed on, etc.). A token may include images and/or text (e.g., numbers and/or characters). A token may include one or more redemption codes, which are redeemable for reward(s). A token may include (e.g., in addition to redemption code(s)) the paper product brand, packaging information, logos, slogans, redemption information, and/or any other appropriate information. The token may be a chance token, in some implementations. For example, a chance token may be associated with an entry in a lottery, a lottery reward, and/or a chance for winning a prize.

A first user may purchase one or more paper products (e.g., individually, as part of a set, as part of a subscription). The first user may be a member of one or more associated sets of users. For example, users may be grouped an association with a primary users. A primary user may refer users in an associated set of users to the PPA system. The primary user may have more than one associated set of users. In some implementations, primary user(s) may be members of associated sets of users associated with another primary user. Thus the first user may be a direct member some associated sets of users and an indirect member of other associated sets of users (e.g., the primary user of an associated set of users to which the first user belongs may be a member of a second associated set of users to which the first user is an indirect member). The first user may be primary user to one or more subsets of users (e.g., that the first user referred to the PPA or that members of the subset referred to the PPA). Since, in some implementations, the PPA may reward the first user based on purchases by the first user and purchases by members of one or more subsets of users, the PPA may track associations between users and purchases of members. The PPA may reward primary users when a member of a set of users (e.g., associated set and/or subset) purchases and/or redeems tokens (e.g., redemption codes) but may not reward other members (e.g., other than the first user) of the set of users, in some implementations.

In various implementations, the PPA may include any appropriate server, such as a web server. The PPA may include a memory that stores associations between one or more of the redemption codes and one or more of the rewards, user information, user association information, reward information, etc. A memory of the PPA may store instructions (e.g., modules) operable to perform operations such as managing paper product sales, token redemptions, user groups, other described operations, and/or any other appropriate operations. A processor of the PPA may execute one or more of the instructions to perform the operations.

For example, the PPA may (e.g., by execution of instructions) receive user information from a user. The user information may identify the user and one or more associated sets of users, and the user may be a direct or indirect member of the one or more associated sets of users.

At least one of the redemption codes on at least one of the tokens disposed on one of the outer surfaces of one of the paper products may be received from the user. A paper product may include one or more tokens and a user may select to provide one or more of the tokens on a paper product to the PPA. A user interface may be generated by the PPA to facilitate receipt of redemption codes. In some implementations, an image of a token disposed on one of the outer surfaces of one of the paper products may be received. The image may be decoded and at least one redemption code may be identified from the image of the token. In some implementations, the decoding of the image may include decoding codes, such as QR and/or barcodes. Decoding an image may include text (e.g., identification of an alphanumeric code) and/or image recognition (e.g., identify a tree and/or type of tree). In some implementations, a user may enter the redemption code on a user device to provide the redemption code to the PPA system (e.g., the redemption code may include an alphanumeric code that can be entered into a user interface generated by the PPA).

Reward(s) for the user may be determined (e.g., by the PPA) based on the received redemption code(s). The PPA may retrieve stored associations between the one or more redemption codes and the one or more rewards and determine the reward associated with the associated with the redemption code(s) received by the PPA. Rewards may be determined for at least one primary user of at least one of the associated sets of users based on the received at least one redemption code. In some implementations, a user's reward may be based on redemption codes redeemed (e.g., submitted to the PPA) by the user and/or redemption code(s) received from user(s) subset(s) of users, in which the user is a primary user. For example, users may receive rewards based on redemption codes submitted by the users and predetermined other users, such as users that are directly referred to the PPA by the user (e.g., a first level subset of users) and one or more levels of indirectly referred users (e.g., second or greater level of subset of users). Rewards may include any appropriate reward, such as points, gift cards, debt payoff amounts, debit cards (e.g., new and/or transfer of money to a debit card), tree plantings, etc. For example, a redemption code may be associated with tree planting.

For example, redemption code may be associated with one or more tree plantings or portions thereof. A number of trees planted based on the user's purchase of the paper product associated with the received at least one redemption codes may be identified. Allowing funding of a tree planting may include providing money (e.g., via conventional banking transfer mechanisms such as EFT) to an organization that provides tree planting services. In some implementations, the PPA may allow users to save points received as rewards and exchange the points for tree planting and the PPA may allow funding of the tree planting based on the exchanged points. A user may save points and/or tree planting rewards to receive the emotional benefit of planting a larger number of trees and/or dedicating a number of trees planted to another person. In some implementations, the number of trees planted based on the user's purchase may be stored and may be tracked (e.g., over a time period). The stored and/or tracked information may be presented to the user and/or other users (e.g., via user interfaces such as dashboards and/or maps). For example, the PPA may present a graphical representation of trees planted based on the user redemptions and/or redemptions associated with the user (e.g., subsets of users for which the user is a primary user). The number of trees planted based on the user's purchase may be presented primary user(s) of associated groups to which the user is a member.

In some implementations, a token may include a chance token and the reward associated with a received/redeemed redemption code may include a allowing the user to be entered into a lottery and/or determining whether a redemption code is associated with a lottery reward.

In some implementations, a reward may include debt payoff. A debt payoff value associated with a received redemption code may be determined (e.g., by the PPA). An identification of a debt may be received from the user. The debt payoff value may be allowed to be applied to the debt by allowing the debt payoff value to be credited to the debt, in some implementations. For example, the PPA may allow the debt payoff value to be transferred (e.g., via conventional banking transactions such as issuing a check, EFT, etc.) to pay the debt (e.g., mortgage, credit card, car loan, etc.). Thus, purchases of paper products and building a subset of users that may purchase paper products may allow a user to pay down debt using products that a user may use anyways.

In some implementations, a zone of influence of a user may be determined by the PPA. The PPA may track user purchases and/or associations between users. A map may be generated (e.g., by the PPA) and a location of the user may be presented on the map. A zone of influence may be identified and presented on the map. The zone of influence may include identifying and/or presenting location(s) user(s) in subsets of users, in which the user is a primary user, and/or other subsets of users associated directly or indirectly with members of the subset of users.

In some implementations, a reward may include a song. For example, a reward for redemption of one or more redemption codes may include allowing the download of a song (e.g., in addition to other rewards or in place of other rewards). For example, when the user provides a redemption code (e.g., associated with a token on a paper product), the PPA may retrieve a song available for the user to download via a user interface generated by the PPA, generate a link to a song available for the user to download from another site (e.g., public accessible library or proprietary library such as the iTunes Store), automatically load the retrieve song into the user's library (e.g., device based and/or cloud based), provide a code that allows the user to download the song on a library (e.g., public and/or private), etc.

In some implementations, the PPA may have a PPA media library that includes media such as songs. The songs may be available from the library and/or the library may retrieve the songs from other libraries. The PPA library may be customizable and/or rotatable (e.g., content may change on a periodic schedule), in some implementations. For example, the library may rotate and thus the song retrievable with a redemption code may change based on when the redemption code is received by the PPA system. For example, in month X, a first redemption code may allow download of song A while in month Y, the same first redemption code may now allow download of song G instead of song A. In some implementations, the redemption code may include segments that are decoded to identify the song the first user is capable of downloading. For example, a segment of the redemption code may indicate the library from which the song may be downloaded, the style of music, whether a user can provide input regarding the nature of the song, etc. A library from which the user may be allowed to download may be based on the type of paper product and/or type of subscription. For example, a family pack of paper products and/or family subscription pack may include a segment that allows download of songs from a family library. The family library may include genres that appeal to a wide range of ages, may include restrictions (e.g., regarding explicit lyrics), etc. In some implementations, a premium paper product may have access to a premium library (e.g., Sony library) while other paper products have access to other libraries. The song identified as a reward may be based on segment(s) of the redemption code received from the user. For example, a segment of the redemption code may be linked to a style of music such as Rock and Roll, Rap, Classical. When the user redeems the redemption code, the redemption code may be decoded to identify the segment associated with the music style and/or library and the PPA may retrieve the reward song based on the segment information. The PPA may select the song randomly and/or based on criteria. For example, a song may be selected based on segment information and/or user information (e.g., number of paper products purchases, type of paper product purchased, songs previously downloaded, subscription type, etc.).

In some implementations, the PPA may facilitate manage the PPA library to facilitate entry of new music, to facilitate rotation of music, etc. For example, a library may rotate music such that at least a portion of the songs in the library are removed and a new set of music is added to the library. The PPA may rotate the PPA library contents on periodically and/or manually (e.g., as desired).

The songs in the PPA library may include custom songs and/or songs commercially available. In some implementations, the reward may include allowing a user to select the song to download rather than and/or in addition to allowing the PPA to select a song for download as a reward. The PPA may automatically play the song or portion thereof when the redemption code is redeemed.

In some implementations, the PPA system may allow all users to be winners. For example, a user that logs into the system (e.g., singularly and/or repeatedly) may be provide a first reward (e.g., coupons). The PPA may provide rewards to any user that redeems a code, such as a chance to win a lottery, debt payment, gift card, coupon, merchandise, etc. The PPA may provide rewards to groups of users (e.g., subset of users) to which the user is a primary user (e.g., such as users referred to the PPA by the user) and/or to the user when users in the groups of users redeem redemption codes. Thus, everyone may be a winner when utilizing the PPA system since each user may receive paper products and a reward.

In various implementations, described processes may be implemented by various described systems. In addition, various operations may be added, deleted, and/or modified. In some implementations, process(es) and/or operation(s) may be performed in combination with other process(es) or portions thereof.

Although users have been described as a human, a user may be a person, a group of people, a person or persons interacting with one or more computers, and/or a computer system.

The PPA may reside on the user device (e.g., any appropriate device such as a mobile device, tablet, and/or laptop) and/or a server (e.g., any appropriate server, such as a web server). For example, the PPA may reside entirely on a memory associated with the server and/or a portion of the PPA may reside on user devices and a second portion may reside on the server. Operations of the PPA may be performed by a computer, such as the user device or server, regardless of whether the instructions for the operation are stored on the computer, in some implementations. In some implementations, a portion of the operation may be performed by one computer and a portion of the operation may be performed by another computer. In some implementations, the decision of which operations are performed by which computer may be based on factors such as communication connection information (e.g., operations may be performed on a user device when not connected to WiFi to reduce expenses related to data consumption), user device information (e.g., when a user device is substantially slower than average user devices, the server may performing more operations), etc.

In various implementations, one or more graphical user interface(s) (GUI) may be generated by the PPA system and displayed on a presentation interface of a user device, such as a monitor or screen, of a user device. The GUI may be operable to allow the user of a user device to interact with repositories and/or various interface(s). Generally, GUI provides a user with an efficient and user-friendly presentation of data provided by the PPA system. GUI includes a plurality of displays having interactive fields, such as image icons, text icons, tabs, pull-down lists, fillable fields, and editable text operated by the user. And in one example, GUI presents an explore-type interface and receives commands from the user. It should be understood that the term graphical user interface may be used in the singular or in the plural to describe one or more graphical user interfaces in each of the displays of a particular graphical user interface. Further, GUI contemplates any graphical user interface, such as a generic web browser, that processes information in the PPA system and/or user device and efficiently presents the information to the user. In some implementations, GUI may present a web page embedding content. The server can accept data from a user device(s) via the web browser (e.g., Safari, or Google Chrome) and return the appropriate Hyper Text Markup Language (HTML) or eXtensible Markup Language (XML) responses.

Although the PPA has been described as including a server, the PPA can be implemented using computers other than servers, as well as a server pool. For example, a server may include a general-purpose personal computer (PC), a Macintosh, a workstation, a UNIX-based computer, a server computer, or any other suitable device. According to one implementation, a server may include a web server. Server may be adapted to execute any operating system including UNIX, Linux, Windows, or any other suitable operating system. In short, server may include software and/or hardware in any combination suitable to provide access to data and/or translate data to an appropriate compatible format.

A single processor and/or multiple processors may be used according to particular needs, and reference to processor is meant to include multiple processors where appropriate. Processor may include a programmable logic device, a microprocessor, or any other appropriate device for manipulating information in a logical manner.

A memory of the server (e.g., of the PPA), memory of user device(s), and/or additional repositories may be any appropriate form of memory. For example, additional repositories may include a relational database. However, a variety of repositories may be used, such as, SQL databases, relational databases, object oriented databases, distributed databases, XML databases, and/or web server repositories. Furthermore, memory may include one or more forms of memory such as volatile memory (e.g., RAM) or nonvolatile memory, such as read-only memory (ROM), optical memory (e.g., CD, DVD, or LD), magnetic memory (e.g., hard disk drives, floppy disk drives), NAND flash memory, NOR flash memory, electrically-erasable, programmable read-only memory (EEPROM), Ferroelectric random-access memory (FeRAM), magnetoresistive random-access memory (MRAM), non-volatile random-access memory (NVRAM), non-volatile static random-access memory (nvSRAM), and/or phase-change memory (PRAM).

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

In various implementations, module(s) (e.g., sets of instructions) of the PPA system perform one or more of the described operations or portions thereof. One or more of the described processes or portions thereof may be implemented by various systems, such as the described systems. In addition, various operations of the described processes may be added, deleted, and/or modified.

These computer programs (also known as programs, software, software applications or code) include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any non-transitory signal used to provide machine instructions and/or data to a programmable processor.

To provide for interaction with a user, the systems and techniques described here can be implemented on a computer having a display device (e.g., LCD (liquid crystal display) monitor or mobile device screen) for displaying information to the user and an input device (e.g., a keyboard, a pointing device such as a mouse and/or a track pad, and/or touch screen) by which the user can provide input to the computer. Other kinds of devices can be used to provide for interaction with a user as well; for example, feedback provided to the user by an output device can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other. Updates to the IMD system may be pushed to clients via a network.

It is to be understood the implementations are not limited to particular systems or processes described which may, of course, vary. It is also to be understood that the terminology used herein is for the purpose of describing particular implementations only, and is not intended to be limiting. As used in this specification, the singular forms “a”, “an” and “the” include plural referents unless the content clearly indicates otherwise. Thus, for example, reference to “an image” includes a combination of two or more images and reference to “a paper product” includes different types and/or combinations of paper products.

Although the present disclosure has been described in detail, it should be understood that various changes, substitutions and alterations may be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A paper product system comprising:
a plurality of paper products, wherein each of the paper products comprises:
a core, and wherein the core comprises:
an inner surface;
an opposing outer surface;
one or more tokens disposed on the outer surface of the core, wherein the token comprises one or more redemption codes that are redeemable for at least one reward; and
a length of paper product wrapped around the core.
a memory storing:
one or more instructions; and
associations between one or more of the redemption codes and one or more of the rewards; and
one or more processors configured to execute one or more of instructions operable to:
receive user information from a user, wherein the user information identifies the user and one or more associated sets of users, and wherein
the user is a direct or indirect member of the one or more associated sets of users;
receive at least one of the redemption codes on at least one of the tokens disposed on one of the outer surfaces of one of the paper products from the user;
determine one or more rewards for the user based on the received at least one redemption codes and the stored associations between the one or more redemption codes and the one or more rewards; and
determine one or more rewards for at least one primary user of at least one of the associated sets of users based on the received at least one redemption code.

2. The system of claim 1 wherein one or more of the instructions are further operable to receive an image of one of the tokens disposed on one of the outer surfaces of one of the paper products to receive the at least one redemption code.

3. The system of claim 2 wherein one or more of the instructions are further operable to decode the received image of one of the tokens to determine one of more of the redemption codes.

4. The system of claim 1 wherein at least one of the redemption codes is associated with tree planting, wherein one or more of the instructions are further operable to: allowing funding of a tree planting by providing money to an organization that provides tree planting services.

5. The system of claim 1 wherein one or more of the instructions operable to determine one or more rewards for the user based on the received at least one redemption codes comprises identifying a number of trees planted based on the user's purchase of the paper product associated with the received at least one redemption codes.

6. The system of claim 5 wherein one or more of the instructions are further operable to:
store the number of trees planted based on the user's purchase,
track the number of trees planted over a time period associated with the user.

7. The system of claim 5 wherein one or more of the instructions are further operable to present, to at least one primary user of at least one of the associated sets of users, the number of trees planted based on the user's purchase.

8. The system of claim 1 wherein one or more of the instructions operable to determine one or more rewards for the user based on the received at least one redemption codes comprises at least one of:
allowing the user to be entered into a lottery;
or determine whether at least one of the redemption codes is associated with a lottery reward.

9. The system of claim 1 wherein one or more of the instructions operable to determine one or more rewards for the user based on the received at least one redemption codes comprises:
determining a debt payoff value associated with the at least one redemption code;
receiving an identification of a debt from the user;
allowing the debt payoff value to be applied to the debt by allowing the debt payoff value to be credited to the debt.

10. The system of claim 1 wherein the user is a primary user for one or more subsets of users, and wherein one or more of the instructions operable to determine one or more rewards for the user is further based on at least one of:
received one redemption codes from one or more users in at least one of the subsets of users,
or one or more purchases of the users in the one or more subsets of users.

11. The system of claim 1 wherein one or more instructions operable to determine one or more rewards for the user based on the received at least one redemption codes comprises:
allowing the user to download a song; and
providing at least one other reward to the user.

12. The system of claim 1 wherein the user is a primary user for one or more subsets of users, wherein one or more of the instructions are further operable to:
generate a map;
identify a location of the user on the map;
identify a zone of influence on the map, wherein the zone of influence comprises identifying a location of one or more users in one or more of the subsets of users.

13. A method of managing redemption of tokens on paper products, the method comprising:
receiving user information from a user, wherein the user information identifies the user and one or more associated sets of users, and wherein the user is a direct or indirect member of the one or more associated sets of users;
receiving, from the user, at least one redemption code associated with one or more paper products, wherein at least one of the redemption codes is associated with a token disposed on one of the outer surfaces of one of the paper products;
determine one or more rewards for the user based on the received at least one redemption codes; and
determine one or more rewards for at least one primary user of at least one of the associated sets of users based on the received at least one redemption code.

14. The method of claim 13 wherein the user is a primary user for one or more subsets of users, and further comprising:
determining purchases of users in the one or more subsets of users; and
determining a reward for the user based on purchases of the users in the one or more subsets of users.

15. The method of claim 13 wherein determining one or more rewards for the user based on the received at least one redemption codes comprises:
receiving an identification of a debt from the user;
determining a debt payoff value associated with the at least one redemption code;
allowing the debt payoff value to be applied to the debt by allowing the debt payoff value to be credited to the debt.

16. A paper product comprising:
a core, wherein the core comprises:
an inner surface;
an opposing outer surface; and
one or more tokens disposed on the outer surface of the core, wherein the token comprises one or more redemption codes that are redeemable for one or more rewards; and
a length of paper product wrapped around the core.

17. The paper product of claim 18 wherein at least one of the redemption codes comprises an image.

18. The paper product of claim 18 wherein at least one of the tokens comprise a chance token.

19. The paper product of claim 18 wherein at least one of the token comprises at least one of a paper product brand, packaging information, logo, slogan, or redemption information.

20. The paper product of claim 18 wherein the one or more tokens are at least one of affixed to, embossed on, or printed on the core.
